(19) United States
(12) Patent Application Publication
(10) Pub. No.: US 2026/0109845 A1
(43) Pub. Date: Apr. 23, 2026

(54) SHAPE MEMORY POLYMER AND RESIN COMPOSITION THEREOF

(71) Applicant: Nano and Advanced Materials Institute Limited, Hong Kong (CN)

(72) Inventors: YONG ZHU, Hong Kong (CN); YANGFAN ZHOU, Hong Kong (CN); JIANPING HAN, Hong Kong (CN); YINGSHUN LI, Hong Kong (CN); PAOCHIEH WANG, Hong Kong (CN); LI FU, Hong Kong (CN); CHENMIN LIU, Hong Kong (CN)

(21) Appl. No.: 18/923,007

(22) Filed: Oct. 22, 2024

(51) Int. Cl. C08L 27/06; C08L 75/04

(52) U.S. Cl. CPC C08L 27/06; C08L 75/04; C08L 2201/12

(57) ABSTRACT

The present invention discloses a shape memory polymer and resin composition thereof. The shape memory polymer comprising a polymer blend of a polyvinyl chloride and a polyurethane, the polyurethane being prepared from a reaction mixture consisting essentially of:
(A) at least one diisocyanate compound; and
(B) a long chain polyol;
   wherein the polyvinyl chloride is configured to be the hard segment that preserves the original shape, and the polyurethane is configured to be the soft segment that forms the temporary shape.

### TECHNICAL FIELD

The present invention relates to the technical field about shape memory polymer (SMP) material, in particular to shape memory polymer blend of polyvinyl chloride and polyurethane.

### BACKGROUND

Deformable plastic toys, tools and ornaments provide a higher degree of interaction compared to stationary ones. However, current methods for achieving shape deformability require intricate design and manufacturing processes, such as incorporating multiple parts and joints or utilizing complex injection molding techniques with multiple layers. As a result, the availability of shape-changing plastic toys is limited, and they are often not cost-effective. Efforts to improve the accessibility and affordability of such toys are focused on the material aspect. Shape memory polymers (SMP) are being considered as a potential solution to address this issue because their material properties enable easy deformation and the ability to retain a new shape, reverting to the original form when subjected to an external stimulus.

### SUMMARY

The present invention provides a composite resin composition containing polyvinyl chloride and polyurethane elastomer, which offers a unique advantage in the production of shape-change toys, tools, or ornaments using standard injection molding equipment typically utilized for PVC items. These items exhibit a dual nature, maintaining the inherent rigidity of traditional PVC plastics when operated below a specific transition temperature. However, upon exposure to elevated temperatures, they become bendable and can be reshaped into alternative configurations. This innovative material blend combines the durability and stiffness of PVC with the flexibility and shape memory properties of PU elastomers, providing a versatile solution for creating dynamic and interactive products that can adapt to different conditions and user preferences.

In one embodiment, the present invention discloses a shape memory polymer comprising a polymer blend of a polyvinyl chloride and a polyurethane, the polyurethane being prepared from a reaction mixture consisting essentially of:
(A) at least one diisocyanate compound; and
(B) a long chain polyol, with molecular weight from 500 to 5000, is present in an amount more than 80 weight percent of the polyurethane, and the functionality of the long chain polyol ranges from 2 to 3;
   wherein the polyvinyl chloride is configured to be the hard segment that preserves the original shape, and the polyurethane is configured to be the soft segment that forms the temporary shape.

In another embodiment, the present invention discloses a composite resin composition for fabricating the above-mentioned shape memory polymer, containing:
(A) polyvinyl chloride particles made from the above-mentioned polyvinyl chloride; and
(B) polyurethane particles made from the above-mentioned polyurethane,
   wherein the particle diameter of polyvinyl chloride particles and polyurethane particles could range from 0.5 to 8.0 mm.

The above description is only an outline of the technical schemes of the present invention. Preferred embodiments of the present invention are provided below in conjunction with the attached drawings to enable one with ordinary skill in the art to better understand said and other objectives, features and advantages of the present invention and to make the present invention accordingly.

### BRIEF DESCRIPTION OF THE DRAWINGS

The present invention can be more fully understood by reading the following detailed description of the preferred embodiments, with reference made to the accompanying drawings, wherein:

FIG. 1 illustrates the working mechanism of the Tm-SMP.

FIG. 2 shows the chemical structure of polyester polyol.

FIG. 3 shows the chemical structure of diisocyanates.

FIG. 4 illustrates the process to synthesis polyurethane SMP material.

FIG. 5 exhibits the Tm of the SMP material Measured by Dynamic Scanning calorimetry (DSC) Analysis.

FIG. 6 exhibits the Dynamic Mechanical Analysis (DMA) result of the elastic modulus ratio changes with increase of temperature and the Tm measured.

FIG. 7 illustrates the process of injection molding.

FIG. 8 shows the injection molded tensile specimen using the SMP material and their shape memory feature.

FIG. 9 shows the injection molded toys made with SMP material.

FIG. 10 shows the mask printed and radiation intensified toys demonstrating their shape memory feature.

FIG. 11 shows schematic illustration of thermomechanical cycle of SMPs.

FIG. 12 illustrates the process for the test of shape fixation properties, and the behavior of the deforming of SMP with respect to its unfolding angles.

### DETAILED DESCRIPTION

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition, an apparatus, or a method described herein can be combined in a variety of ways without departing from the spirit and scope of the present teachings, whether explicit or implicit herein.

### Definitions

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

It should be understood that the order of steps or order for performing certain actions is immaterial so long as the present teachings remain operable. Moreover, two or more steps or actions may be conducted simultaneously.

Unless defined otherwise, all technical and scientific terms used herein have the same meaning as commonly understood to one of ordinary skill in the art to which the presently described subject matter pertains.

### Shape Memory Polymer (SMP)

As an intelligent material, shape memory polymer (SMP) can keep its temporary state and recover to its initial state under different stimuli such as solution, light, electricity, etc. The most favorable characteristic of SMP is that its stiffness is adjustable. SMP is in rubber state when ambient temperature is higher than transition temperature (Tₜᵣₐₙₛ). When the temperature decreases, stiffness and storage modulus of the material increase gradually.

In general, SMP is in a two-phase structure, fixed phase and reversible phase, which possesses inseparable synergy to maintain the initial shape and contribute the shape-shifting ability. The fixed phase plays a significant role in maintaining and recovering original shape and preventing flow deformation of polymer. SMP may undergo reversible changes of softening and hardening by altering external conditions (for example temperature), which contribute polymer deformability.

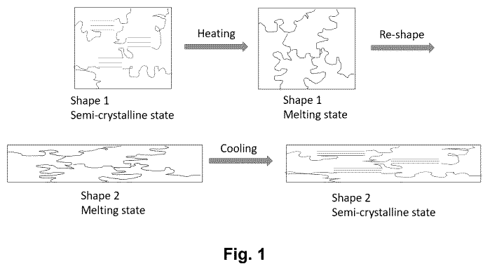

Tm-SMP has a crystalline melting temperature (Tm) and crystalline temperature (Tc). When the temperature is above the Tm, the polymer is in rubbery state. The material is soft and easy to deform. When the temperature is below the Tc, the polymer will crystallize. In such state, the molecular chain is “frozen” and the shape is fixed. The re-shapeable mechanism for Tm-SMP is shown in FIG. 1.

### Composition and Preparation of Polyurethanes

Polyurethanes, are generally synthesized from an isocyanate reaction with a polyol. Diisocyanate and polyhydroxy compounds are the main components that undergo polyaddition polymerization reaction for the production of polyurethanes. Polyurethanes were commercially used as malleable elastomers, coatings, adhesives, flexible foams, and rigid polyurethane.

Depending upon the application, their density ranges from 40 to 1,220 kg/m³ and polyurethane vary from elastomers to flexible, rigid, and hard foams. Cross-linking agents or chain extenders and catalysts are also used in the polyurethane preparation. The properties of polyurethane can be tailor made and depend upon the chemical composition of the isocyanate and polyol, NCO:OH ratio as well as the chain extender used. NCO:OH ratio can be controlled by using isocyanates, polyols, and chain extender components. The structure of the molecular backbone and the chain extender imparts enhanced mechanical and thermal properties of polyurethanes. Difunctional BDO (1,4-butanediene) is commonly used as chain extender. The cross-linkers/chain extenders react with the isocyanate to create the hard segment while the polyol is used to create a soft segment for the polyurethane.

### Effect of Chemical Composition on Mechanical Properties of Polyurethane

As mentioned above, polyurethane may be tailored to be rigid or flexible because the structure consists of soft and hard segments. The soft segments are formed by polyols, which affect the flexibility and elastomeric character of polyurethane, whereas the hard segments are formed by isocyanate and a crosslinking agent or chain extenders, which affect the rigidity and physical performance.

### Polyol

Polyols are substances bearing more than one functional hydroxyl group, largely classified into either polyether polyols or polyester polyols. Some of the simplest polyols are glycols, likewise ethylene glycol, 1,4-butane diol (BDO) and 1,6-hexane diol. Technically the low molecular weight polyols result in the formation of hard and rigid polyurethane because of the higher concentration urethane linkage, and the shorter chain react more vigorously with the —NCO to produce a higher molecular weight polymer/pre-polymer.

However, when higher molecular weight polyols are used as the key reactants, since they contain chains with fewer urethane groups or lower concentration of the urethane links, and it results in more flexible main chains. Soft elastomeric PU are formed by long chain polyols with lower functionality (2) while short chain polyols of high functionality (greater than 3) give more rigid, cross-linked product. In this invention, long chain polyol with low functionality is used, and is present in large amount in the formulation, to generate PU products with high flexibility.

### PCL-Based PUS

The inclusion of polycaprolactone diol (PCL) typically enhances crystallinity, as PCL is a semi-crystalline polymer. Various studies have explored PCL-based PUs containing urethane and urea groups to improve its mechanical properties. Generally, an increase in the length of the polyol resulted in a decrease in the ratio of the hard segment, leading to an increased tendency of the polyurethanes to crystallize. In a preferred embodiment of this invention, PCL is used as long chain polyol to generate PU products with enhanced crystallinity and good mechanical properties.

### Cross-Linking Agents/Chain Extenders

Cross-linking agents or chain extenders are usually low molecular weight symmetrical diols or diamines. Chain extenders react with isocyanates in the same way as polyols do, but because they are low molecular weight, a high concentration of hydrogen-bonded molecules can associate and phase out of the polyol to form plastic-like domains called “hard segments”.

Segmented polyurethanes are block copolymers built up of alternating soft and hard blocks. A wide range of their properties can be attributed to the large variations in morphologies that can be obtained, which are partly controlled by the presence of physical or chemical crosslinking. Physical crosslinking is mainly derived from the phase separation of the hard-segment domains, while chemical crosslinking can be introduced into segmented polyurethanes in many ways but the most common methods use a triol as chain extender.

In common cases, chemical cross-linking has been found to reduce the crystallinity in both high and low density polymer. The reduction has both a thermodynamic and a kinetic aspect: chemical cross-links can reduce the amount of crystallizable material as well as hinder the mobility of the chains. Chemical cross-links represent significant defects from the viewpoint of a crystal, so it would be naturally expected that crystalline regions would not contain chemical cross-links. In other words, increase in chemical cross-link density causes crystallization to slow down and decrease.

However, for segmented polyurethanes, physical crosslinking mainly stems from the phase separation of the hard-segment domains. The hard-segment itself is formed by chemical crosslinking of chain extenders and isocyanates. Physical crosslinking may increase crystallization in segmented polyurethanes, but formation of this kind of crystalline is affected by many factors and hard to regulate the quantity and quality of the crystalline structures, which may result in a broad melting temperature range.

In this invention, a polyurethane is prepared from a reaction mixture comprising at least one diisocyanate compound and a long-chain polyol, wherein the reaction mixture is substantially free of chain extender. This process aims to produce a polyurethane with very less or no hard segment, thereby eliminating the crystalline structures formed via the phase separation of the hard-segment domains.

In a first embodiment, a shape memory polymer is provided. The shape memory polymer comprises a polymer blend of a polyvinyl chloride and a polyurethane. The molecular weight of the polyvinyl chloride could range from 40,000 to 150,000. Furthermore, the weight ratio of the polyurethane to the polyvinyl chloride could equal to or more than 100/100.

The above-mentioned polyurethane is prepared from a reaction mixture consisting essentially of:
(A) at least one diisocyanate compound; and
(B) a long chain polyol, with molecular weight from 500 to 5000, is present in an amount more than 80 weight percent of the polyurethane, and preferred, more than 90 weight percent.
   wherein the functionality of the long chain polyol ranges from 2 to 3, and 2 is preferred;
   wherein the molar ratio of all diisocyanate compounds to the long chain polyol could be between 0.9 to 1.2;
   wherein the polyvinyl chloride is configured to be the hard segment that preserves the original shape, and the polyurethane is configured to be the soft segment that forms the temporary shape.

The hard segments and the soft segments also possess the function to fix the temporary shape of the shape memory polymer at temperatures below a transition temperature.

In this embodiment, the reaction mixture is substantially free of chain extender, wherein the chain extender is present in an amount less than 5 weight percent of the reaction mixture. Preferred, the chain extender is present in an amount less than 2 weight percent of the reaction mixture.

In this embodiment, the long chain polyol could be polyester polyol or polyester diol. In a preferred case, the long chain polyol is polycaprolactone (PCL).

In this embodiment, a composite shape memory polymer comprising polyvinyl chloride/polyurethane (PVC/PU) blend is provided. The shape memory polymer exhibits a dual nature, maintaining the inherent rigidity of traditional PVC plastics when operated below a specific transition temperature. However, upon exposure to elevated temperatures, the shape memory polymer become bendable and can be reshaped into alternative configurations. In a preferred case, the polymer blend comprises an amorphous polyvinyl chloride and a semi-crystalline polyurethane.

the above-mentioned shape memory polymer comprises one of the following properties:
(1) the transition temperature ranges from 30 to 50 degrees Celsius;
(2) the transition temperature greater than 40 degrees Celsius;
(3) if the appliance is a toy, a transition temperature of 40 to 50 degrees Celsius;
(4) a tensile storage modulus more than 100 MPa at 20 degrees Celsius;
(5) a tensile storage modulus more than 1 MPa at 45 degrees Celsius;
(6) the shape fixity equal to or more than 80 percent.

In a second embodiment, a composite resin composition is provided. The resin composition is for fabricating the shape memory polymer of the first embodiment, contains:
(A) polyvinyl chloride particles made from the polyvinyl chloride of the first embodiment; and
(B) polyurethane particles made from the polyurethane of the first embodiment,
   wherein the particle diameter of polyvinyl chloride particles and polyurethane particles could range from 0.5 to 8.0 mm.

In this embodiment, the resin composition could further contain plasticizers and nucleation agents.

In this embodiment, the shape memory polymer could be fabricated from the resin composition by extrusion, injection molding, casting, compression molding, blow-molding, rotational molding, rapid prototyping, solid freeform fabrication, or combinations thereof.

In a preferred case, the shape memory polymer is fabricated by injection molding, with an operation pressure of 40 to 100 bar and an operation temperature of 100 to 200 degrees Celsius.

After the injection molding, the fabricated shape memory polymer may be further processed with radiation of 10˜100 kGy for crosslinking. The radiation includes electron beam, gamma ray or X-ray.

### Example 1-Fabrication of Shape Memory Polymer

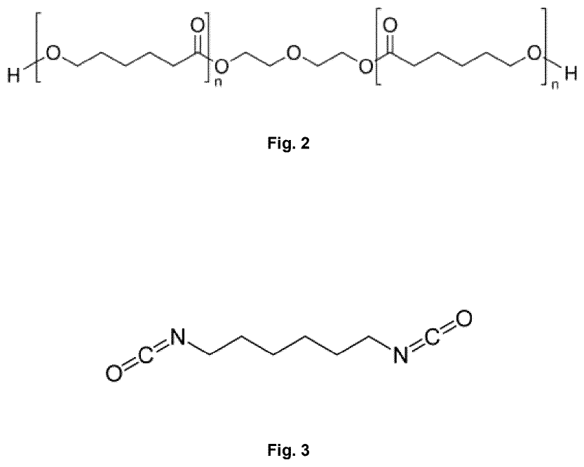

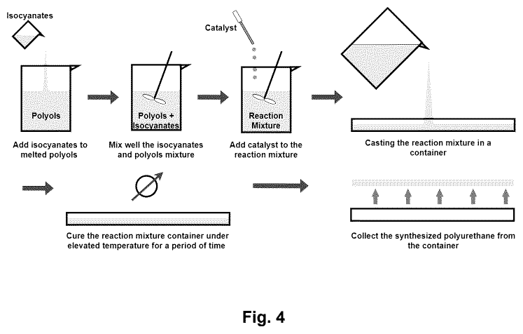

The polyurethane is synthesized using polyols (FIG. 2) with a molecular weight ranging from 500 to 5000, reacting with isocyanates (FIG. 3). The effective molar ratio of polyester polyol to isocyanates is between 0.9 to 1.2, while the molar ratio between isocyanates can be around 1.0. The polyol is heated to 50-200° C., followed by the addition of other chemicals including isocyanates, crosslinkers, catalyst to create a reaction mixture. A catalyst is then added, and the mixture is thoroughly mixed.

Then, the reaction mixture is poured into a non-sticky container and placed in a heated environment with a temperature ranging from 60° C. to 200° C. for curing, which lasts 2 to 12 hours, resulting in the formation of polyurethane.

Once the reaction is complete, the synthesized polyurethane is removed from the container and processed into small particles sized between 0.5 mm to 9 mm, matching the size of PVC particles for injection molding.

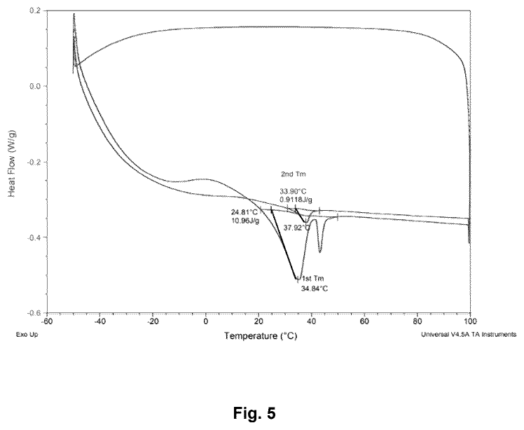

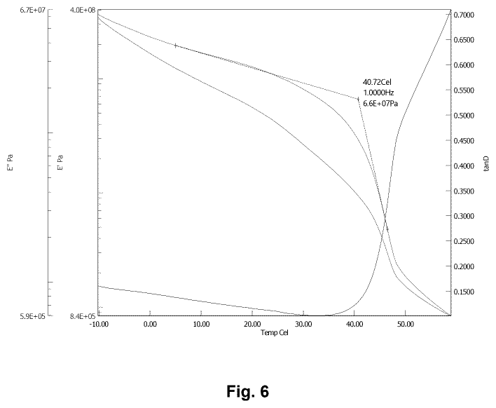

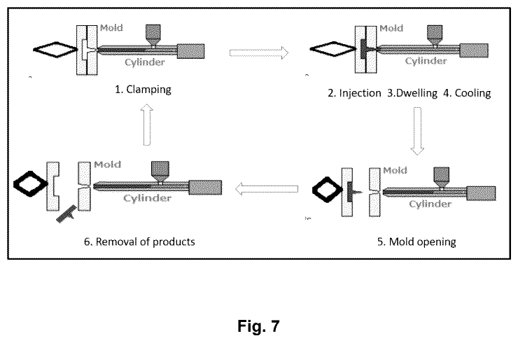

Afterwards, the polyurethane particles are blended with PVC particles at a mass ratio of 1:10 to 10:1 and fed into an extruder with a cutter to create compounding particles. The elastic modulus and melting temperature (Tm) of this material are then measured (FIG. 5 and FIG. 6).

Moreover, the compounding particles are fed into an injection molding machine operating at temperatures between 100 to 200° C. and injection molding pressures ranging from 40 to 100 bar. Injection molding time spans from 1 to 20 seconds, with post-pressure time ranging between 20 to 120 seconds.

Finally, the toys, tools, or ornaments produced from the injection molding machine undergo radiation treatment to enhance their structure. Radiation methods such as ultraviolet, electron beam, or gamma ray can be used.

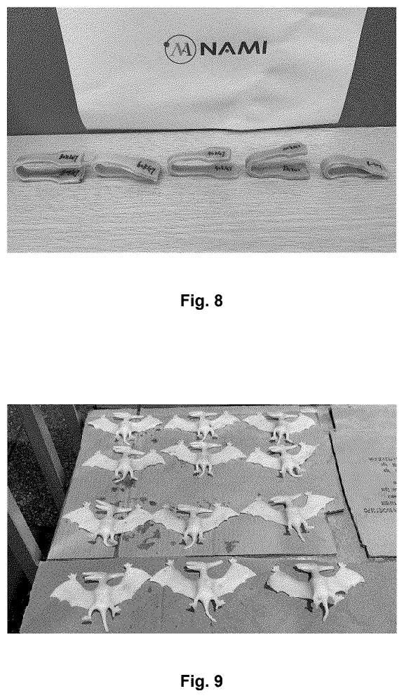

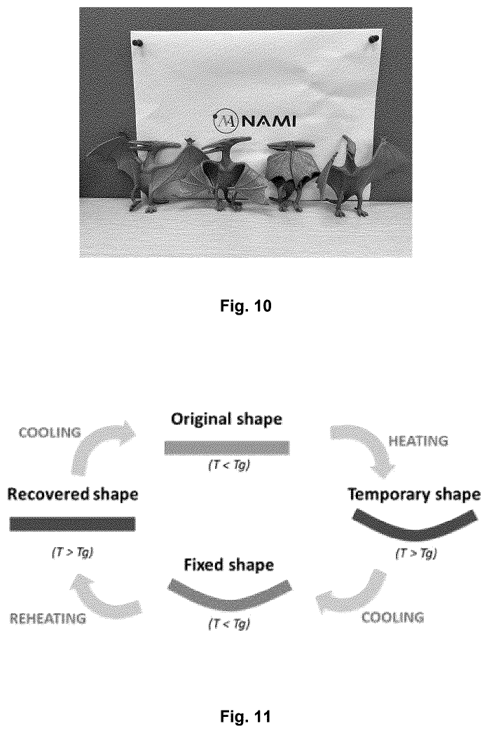

Following radiation treatment, the toys, tools, or ornaments undergo mask printing, and the shape memory feature is verified (FIG. 8 and FIG. 10).

### Example 2-Polyol MW Sensitivity

The melting temperature range (Tm) of the synthesized shape memory polymer (SMP) is primarily determined by the molecular weight (MW) of the polyol. Generally, larger molecular-sized polyols have higher melting points, resulting in SMPs with higher Tm values. This example presents a sensitivity study of the impact of MW on the Tm of the finished composite product.

### Materials and Procedures

1000 g of Polycaprolactone (PCL) of CAPA2101, CAPA2141A, CAPA2201A and CAPA2303 from Ingevity with molecular weight (MW) of 1000, 1400, 2000 and 3000 respectively are heated to 100° C. and dehydrated under vacuum for 60 min before use. Each of the PCL was reacted with equivalent molar amount of HDI from Aladdin Scientific, for 1000 g of CAPA2101, CAPA2141A, CAPA2201A and CAPA2303, 178.2 g, 127.4 g, 89.1 g and 59.4 g HDI was added respectively along with 1 ml of DABCO® T12 catalyst from Evonik as the catalyst.

Then, each reaction mixture was casted into a PP (Polypropylene) Plate and cured in an oven at 100° C. for 8 hours. The resulting polyurethane plate is processed into small particles using a blending machine with a cooling system, maintaining a chamber temperature of 10° C. The filter size used is 4 mm. Afterwards, the 4 mm polyurethane particles are combined with equivalent-sized PVC in a 6:2 ratio and fed into an extruder operating at 150° C. to produce SMP compounding material. The extruder nozzle generates 4 mm SMP granules.

The compounding particles are then injected into a molding machine at 120° C. and molded at 50 bar pressure. The injection molding process lasts 9 seconds, with a post-pressure time of 40 seconds. An star shaped ornament mold is utilized. Finally, the star ornaments undergo e-Beam treatment with a dose of 40 kGy to enhance their crosslink structure.

### PCL Molecular Weight and Tm Range of SMP

The finished star shaped ornaments' melting temperature was measured using DSC and DMA and are summarized in Table 1. It was observed that Tm is directly proportional to the molecular weight of PCL. In a preferred case, PCL with a molecular weight equal to or exceeding 2000 g/mol is used. As a result, the transition temperature of the fabricated shape memory polymer could be greater than 40 degrees Celsius.

TABLE 1

| PCL MW | 1000 g/mol | 1400 g/mol | 2000 g/mol | 3000 g/mol |
|---|---|---|---|---|
| Tₘ range of the star ornaments | 20-30° C. | 30-40° C. | 40-45° C. | 45-55° C. |

### Example 3—Isocyanates Sensitivity

Precise control over the Tm can be achieved by adjusting the degree of crystallinity through the selection and manipulation of isocyanates. In theory, linear isocyanate molecules such as hexamethylene diisocyanate (HDI) promote the formation of more crystals, resulting in higher Tm values and storage modulus (E′) for the polyurethane (PU) product. In this example the sensitivity analysis of the use of Isocyanates is presented.

### Materials and Procedures

First, 5000 g of CAPA2201A (2000MW PCL) is heated at 100° C., dehydrated, and divided into five even portions (1000 mL each) into five 2000 mL containers. Next, to each portion of CAPA2201A, equivalent mol of isocyanates was added. The isocyanates added here are HDI from Aladdin and IPDI from fisher scientific. For the five portions of CAPA2201A, pure HDI, HDI to IPDI 3:1 (molar ratio), HDI to IPDI 1:1, HDI to IPDI 1:3 and pure IPDI were added to each portion respectively. The mass of the HDI and IPDI added for different portions are summarized in Table 2. For each portion, 1 ml of DABCO® T12 catalyst from Evonik is added to start the reaction.

TABLE 2

| HDI to IPDI Ratio | Pure HDI | | HDI:IPDI 3:1 | | HDI:IPDI 1:1 | | HDI:IPDI 1:3 | | Pure IPDI | |
|---|---|---|---|---|---|---|---|---|---|---|
| HDI Mass | 89.1 | g | 66.83 | g | 44.5 | g | 22.3 | g | 0 | g |
| IPDI Mass | 0 | g | 27.8 | g | 55.6 | g | 83.4 | g | 111.15 | g |
| CAPA2201 Mass | 1000 | g | 1000 | g | 1000 | g | 1000 | g | 1000 | g |

Then, the reaction mixtures are casted into five different PP plates and cured in an oven at 100° C. for 9 hours. The resulting PU plates are processed into small particles using a blending machine with a cooling system, maintaining a chamber temperature of 10° C. The filter size used is 4 mm. Afterwards, the 4 mm polyurethane particles of different isocyanates formulations are combined with equivalent-sized PVC in an 8:2 ratio and fed into an extruder operating at 150° C. to produce SMP compounding material. The extruder nozzle generates 4 mm SMP granules.

The compounding particles of different isocyanates are then injected into a molding machine at 120° C. and molded at 50 bar pressure. The injection molding process lasts 9 seconds, with a post-pressure time of 40 seconds. A tensile strength test specimen mold is utilized.

Finally, the tensile test specimens made of different isocyanate formulations are treated with 120 kGy gamma rays to further intensify the structure.

### Sensitivity Study of Isocyanate Selection on Tm and E′ of Synthesized PU

The storage modulus of the tensile strength specimens with different isocyanate formulations were investigated using tension mode DMA with the sample cut from the specimen with the dimension of 20 mm long, 10 mm width and the operating frequency at 1 Hz. The result is summarized in Table 3.

TABLE 3

| HDI to IPDI Ratio | Pure HDI | HDI:IPDI 3:1 | HDI:IPDI 1:1 | HDI:IPDI 1:3 | Pure IPDI |
|---|---|---|---|---|---|
| Tm[° C.] | 42.5 | 39.8 | 37.3 | 35.4 | 33.5 |
| E′(20° C.)[Pa] | 2.93e8 | 2.63e8 | 2.31e8 | 1.86e8 | 1.69e8 |
| E′(45° C.)[Pa] | 8.49e7 | 5.69e7 | 3.72e7 | 6.09e6 | 5.34e6 |

### Example 4-PU/PVC Ratios Sensitivity

The E′ and Tm values can also be influenced by the ratios between PU and PVC in the composite material. Increasing the portion of PVC in the composite material dilutes the degree of crystallinity, leading to a reduction in Tm. Additionally, the E′ values tend to align more closely with the original PVC material and the shape fixity feature will be undermined which will be illustrated below. This example presents a sensitivity analysis of the PU to PVC ratio on Tm. E′ and shape fixity ratio finished composite product.

### Materials and Procedures

1000 g of CAPA2201A (2000 MW PCL) is heated at 100° C., dehydrated and poured into a 2000 mL container. Equivalent amount of HDI from Aladdin is added. 1 mL of DABCO® T12 catalyst from Evonik is added to start the reaction. Next, the reaction mixtures are casted into a PP plate and cured in an oven at 100° C. for 9 hours.

The resulting PU plate is processed into small particles using a blending machine with a cooling system, maintaining a chamber temperature of 10° C. The filter size used is 4 mm. Then, the 4 mm PU particles are divided into 5 portions, each portion mixed with PVC particles with similar size. Moreover, different amount of PVC is added to each portion to make different PU/PVC ratio blend. The weighted samples are well mixed fed into an extruder operating at 150° C. to produce SMP compounding material. The extruder nozzle generates 4 mm SMP granules.

The compounding particles of different PU/PVC ratios are then injected into a molding machine at 120° C. and molded at 50 bar pressure. The injection molding process lasts 9 seconds, with a post-pressure time of 40 seconds. A tensile strength test specimen mold is utilized. Finally, the tensile test specimens made of different formulations are treated with 20 electron beam to further intensify the structure.

### Sensitivity Analysis of PU/PVC Ratio on Tm, E′ and Shape Fixity

The Tm, E′ of the tensile strength specimens with different isocyanate formulations were investigated using tension mode DMA with the sample cut from the specimen with the dimension of 20 mm long, 10 mm width and the operating frequency at 1 Hz. The result of the sensitivity analysis is presented in Table 4.

TABLE 4

| | PVC Ratio | | | | | | | | |
|---|---|---|---|---|---|---|---|---|---|
| PU | 9:1 | 8:2 | 7:3 | 6:4 | 5:5 | 4:6 | 3:7 | 2:8 | 1:9 |
| Tm[° C.] | 39.6 | 39.0 | 38.3 | 37.9 | 37.8 | 37.3 | 37.0 | 36.9 | 36.8 |
| E′(20° C.)[Pa] | 2.82e8 | 2.49e8 | 2.40e8 | 2.30e8 | 1.86e8 | 1.66e8 | 1.49e8 | 1.24e8 | 1.16e8 |
| E′(45° C.)[Pa] | 4.21e6 | 7.24e6 | 9.53e6 | 2.10e7 | 3.53e7 | 5.24e6 | 6.20e7 | 8.65e7 | 9.87e7 |
| Shape Fixity % | 100 | 100 | 100 | 100 | 80 | 70 | 40 | 0 | 0 |

### Example 5-Characterization of Shape Recovery

FIG. 11 exhibits schematic illustration of thermomechanical cycle of SMPs. At temperatures higher than the glass transition temperature (Tg) or melting temperature (Tm), the polymer chains become relaxed and flexible. In this state, when an external force is applied, the polymer chains can be stretched or contracted extensively, and the network points may also be displaced. However, when the temperature is lowered below Tg or Tm while maintaining the pre-deformed shape, some secondary cross-links can form. These secondary cross-links help fix the polymer in the temporary shape after the external force is removed. Upon reheating, these secondary cross-linked polymers above Tg or Tm are released, and the original shape is recovered.

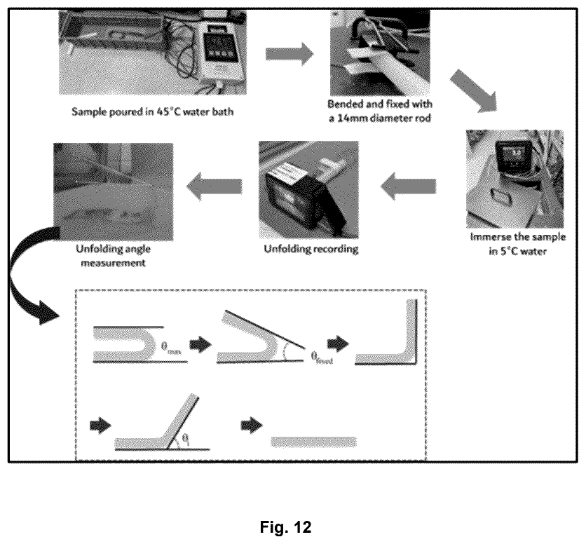

This unique feature of shape memory polymers allows for a bending behavior test to evaluate their shape memory performance. FIG. 12 illustrates the bending behavior test process consisting of three main stages. First, the SMP with its original shape is fixed in a base and heated inside a heating chamber or a water bath. Second, the SMP is folded around a steel shaft to a storage angle (θₘₐₓ) by applying an appropriate force, and then immersed in cool water to fix the shape. Finally, the force is removed, and the folded SMP is placed on a horizontal platform at ambient temperature to observe the bending angle (θᵢ) at different time intervals.

In general, the shape recovery ratio measures how well the SMPs return to their initial shape, while the shape fixation ratio measures how accurately the material can be deformed into a temporary shape. If the fixed bending angle is denoted as θ_{fixed}, mathematically, the shape fixation ratio and recovery ratio can be calculated using the equations shown below. The shape fixity of the specimens is tested using a shape fixity test, which is presented in Table 4. In a preferred case, the weight ratio of the polyurethane to the polyvinyl chloride is equal to or exceeding 100/100. This specific ratio is chosen to ensure that the shape fixity of the fabricated shape memory polymer reaches or surpasses 80 percent.

$$Shape fixation ratio = \frac{{θ}_{fixed}}{{θ}_{max}} \times 100$$

$$Shape recovery ratio = \frac{{θ}_{fixed} - {θ}_{i}}{{θ}_{max}} \times 100$$

### Shape Memory Test Conditions

### Sample Dimensions:*

Thickness: 2.5 mm
Length: 160 mm
Width: 30 mm

### Test Procedure

a. Heat the sample for 5 minutes at 45° C.
b. Clamp the sample and bend it around a 14 mm diameter rod.
c. Cool the sample in 5° C. water for 5 minutes.
d. Remove the clamp and observe if the sample retains its fixity.

The present invention provides a shape memory polymer and composite resin composition thereof. The resin composition contains polyvinyl chloride and polyurethane elastomer. Some unique advantages are listed below:
1. The material of polycaprolactone and isocyanates are used as they together produce polyurethanes with narrow melting temperature range. Because the narrow melting temperature range represents that the product can quickly deform and fix its shape, which has great commercial value. The molecular weight of polyols and the ratios between isocyanates can be changed to modify the distribution and the size of the crystallinity and therefore the Tm of the material that satisfies different applications.
2. PVC and PU are blended together so that the material composite can retain some stiffness by providing the material some hardness segments when it is heated above its melting temperature.
3. The composite material can be injection molded using the standard injection molding machine that is used for making toys, tools and ornaments with PVC material.
4. Radiation technique is used in post treatment and the dose is controlled to intensify the material and promotes more crosslink between molecules which help intensify the structure.

The above embodiments are only used to illustrate the principles of the present invention, and they should not be construed as limiting the present invention in any way. The above embodiments can be modified by those with ordinary skill in the art without departing from the scope of the present invention as defined in the following appended claims.

What is claimed is:

1. A shape memory polymer comprising a polymer blend of a polyvinyl chloride and a polyurethane, the polyurethane being prepared from a reaction mixture consisting essentially of:
(A) at least one diisocyanate compound; and
(B) a long chain polyol, with molecular weight from 500 to 5000, is present in an amount more than 80 weight percent of the polyurethane, and the functionality of the long chain polyol ranges from 2 to 3;
wherein the polyvinyl chloride is configured to be the hard segment that preserves the original shape, and the polyurethane is configured to be the soft segment that forms the temporary shape.

2. The shape memory polymer of claim 1, wherein the long chain polyol is present in an amount more than 90 weight percent of the polyurethane.

3. The shape memory polymer of claim 1, wherein the reaction mixture is substantially free of chain extender.

4. The shape memory polymer of claim 3, wherein the chain extender is present in an amount less than 5 weight percent of the reaction mixture.

5. The shape memory polymer of claim 1, wherein the functionality of the long chain long chain polyol is 2.

6. The shape memory polymer of claim 1, wherein the long chain polyol is polyester polyol or polyester diol.

7. The shape memory polymer of claim 1, wherein the long chain polyol is polycaprolactone (PCL).

8. The shape memory polymer of claim 1, wherein the molar ratio of all diisocyanate compounds to the long chain polyol is between 0.9 to 1.2.

9. The shape memory polymer of claim 1, wherein the weight ratio of the polyurethane to the polyvinyl chloride is equal to or more than 100/100.

10. The shape memory polymer of claim 1, wherein the molecular weight of the polyvinyl chloride ranges from 40,000 to 150,000.

11. The shape memory polymer of claim 1, wherein the polymer blend comprises an amorphous polyvinyl chloride and a semi-crystalline polyurethane.

12. The shape memory polymer of claim 1, wherein the hard segments and the soft segments also possess the function to fix the temporary shape of the shape memory polymer at temperatures below a transition temperature.

13. The shape memory polymer of claim 12, wherein the shape memory polymer comprises one of the following properties:
(1) the transition temperature ranges from 30 to 50 degrees Celsius;
(2) the transition temperature greater than 40 degrees Celsius;
(3) if the appliance is a toy, a transition temperature of 40 to 50 degrees Celsius;
(4) a tensile storage modulus more than 100 MPa at 20 degrees Celsius;
(5) a tensile storage modulus more than 1 MPa at 45 degrees Celsius;
(6) the shape fixity equal to or more than 80 percent.

14. A composite resin composition for fabricating the shape memory polymer of claim 1, containing:
(A) polyvinyl chloride particles made from the polyvinyl chloride of claim 1; and
(B) polyurethane particles made from the polyurethane of claim 1.

15. The resin composition of claim 14, wherein the particle diameter of polyvinyl chloride particles and polyurethane particles ranges from 0.5 to 8.0 mm.

16. The resin composition of claim 14, wherein the resin composition further containing plasticizers and nucleation agents.

17. The resin composition of claim 14, wherein the shape memory polymer is fabricated from the resin composition by extrusion, injection molding, casting, compression molding, blow-molding, rotational molding, rapid prototyping, solid freeform fabrication, or combinations thereof.

18. The resin composition of claim 17, wherein the shape memory polymer is fabricated by injection molding, with an operation pressure of 40 to 100 bar and an operation temperature of 100 to 200 degrees Celsius.

19. The resin composition of claim 18, after the injection molding, the fabricated shape memory polymer is further processed with radiation of 10˜100 kGy for crosslinking.

20. The resin composition of claim 19, wherein the radiation includes electron beam, gamma ray or X-ray.
